(19) United States
(12) Patent Application Publication
(10) Pub. No.: US 2004/0253849 A1
(43) Pub. Date: Dec. 16, 2004

(54) Electrical connector

(76) Inventors: Nobukazu Kuribayashi, Kariya-city (JP); Masahiko Sugaya, Anjo-city (JP); Shigeo Shiba, Toyota-city (JP)

Correspondence Address: HARNESS, DICKEY & PIERCE, P.L.C., P.O. BOX 828, BLOOMFIELD HILLS, MI, 48303, US

(21) Appl. No.: 10/864,674

(22) Filed: Jun. 9, 2004

(30) Foreign Application Priority Data
Jun. 12, 2003 (JP) 2003-167870

(51) Int. Cl. H01R 12/00

(52) U.S. Cl. 439/76.1

(57) ABSTRACT

An electrical connector has a housing, a circuit board, harness terminals, and contact terminals. The housing has a hole and a lid. The circuit board is detachably disposed in the hole. If the circuit board is broken down, the lid is opened and the circuit board is removed from the hole. A new circuit board is then disposed on the terminals in the hole. The lid is closed so that the terminals are elastically deformed and the electrodes of the circuit board are electrically connected to the terminals.

### CROSS REFERENCE TO RELATED APPLICATION

This application is based on Japanese Patent Application No. 2003-167870 filed on Jun. 12, 2003, the contents of which are incorporated herein by reference.

### BACKGROUND OF THE INVENTION

1. Field of the Invention

The present invention relates to an electrical connector. Specifically, the electrical connector is connected to electrical wiring, which is connected to an electrical control unit (ECU), and has a circuit board for controlling a motor-driven actuator.

2. Description of Related Art

A connector having a circuit board for controlling an actuator for driving a door of a vehicle air conditioner is disclosed in JP-A-H11-275801. The connector has a housing, a circuit board, a wire connection, and an actuator connection. The circuit board is disposed within the housing, and a control circuit is mounted on the circuit board. The wire connection is connected to electrical wiring, which is connected to an ECU. The actuator connection is connected to a motor-driven actuator.

In such a connector, the control circuit produces a control signal in response to an input signal from the ECU via the electrical wiring. The control circuit sends the control signal to the motor-driven actuator to control the actuator.

The inventors considered an actuator control system by using the connectors. In the actuator control system, the connectors having the circuit boards are connected in parallel to the electrical wiring extending from the ECU. The connectors are connected to respective actuators. The ECU communicates with the each circuit board of the connector via the electrical wiring. The actuator control system controls a plurality of actuators by using a time division multiple communication.

In such an actuator control system, if one of the circuit boards in the connectors is broken down, all of the connectors and the electrical wiring can be integrally changed to new ones. However, this increases the cost.

Instead, as shown in FIG. 14A-14C, only the connector 90b having the broken circuit board may be cut to remove it, and a new connector 90d may be electrically connected between connectors 90a, 90c through the electrical wiring W/H. However, it is difficult to connect the new connector because of the required processes, such as swage process, soldering process, and isolating process.

### SUMMARY OF THE INVENTION

An object of the present invention is to provide an electrical connector that can be easily repaired.

According to one aspect of the present invention, the electrical connector has a housing, a circuit board, a harness terminal, and an actuator terminal. The circuit board is detachably housed in the housing. The harness terminal connects a wiring harness to the circuit board. The actuator terminal connects an actuator to the circuit board.

Since the circuit board is detachably housed in the housing, the circuit board can be easily changed without changing the entire structure of the wiring harness and the electrical connector. Therefore, it is easy to repair the circuit board with low cost.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing an air conditioner for a vehicle according to a first embodiment of the present invention;

FIG. 2 is a block diagram showing a control system of the air conditioner according to the first embodiment;

FIG. 3 is a schematic diagram showing an actuator according to the first embodiment;

FIG. 4 shows a schematic perspective view of a connector according to the first embodiment;

FIG. 5 shows another schematic perspective view of the connector according to the first embodiment;

FIG. 6A is a schematic top view of another connector according to a second embodiment of the present invention;

FIG. 6B is a schematic side view of the connector according to the second embodiment;

FIG. 7 is a schematic side view of the connector according to the second embodiment;

FIG. 8 is a schematic top view of another connector according to a third embodiment of the present invention;

FIG. 9A is a schematic side view of the connector according to the third embodiment;.

FIG. 9B is a schematic side view of an internal structure of the connector according to the third embodiment;

FIG. 9C is a schematic side view of the connector according to the third embodiment;

FIG. 10 is a schematic top view of another connector according to a fourth embodiment of the present invention;

FIG. 11A is a schematic side view of the connector according to the fourth embodiment;

FIG. 11B is a schematic side view of an internal structure of the connector according to the fourth embodiment;

FIG. 11C is a schematic side view of the connector according to the fourth embodiment;

FIG. 12 is a schematic top view of another connector according to a fifth embodiment of the present invention;

FIG. 13A is a schematic side view of the connector according to the fifth embodiment;

FIG. 13B is a schematic side view of an internal structure of the connector according to the fifth embodiment;

FIG. 13C is a schematic side view of the connector according to the fifth embodiment; and

FIGS. 14A-14C show a connector according to a related art.

### DETAILED DESCRIPTION OF PREFERRED EMBODIMENTS

The preferred embodiments of the present invention will be explained with reference to the accompanying drawings. In the drawing, the same numerals are used for the same components and devices.

### First Embodiment

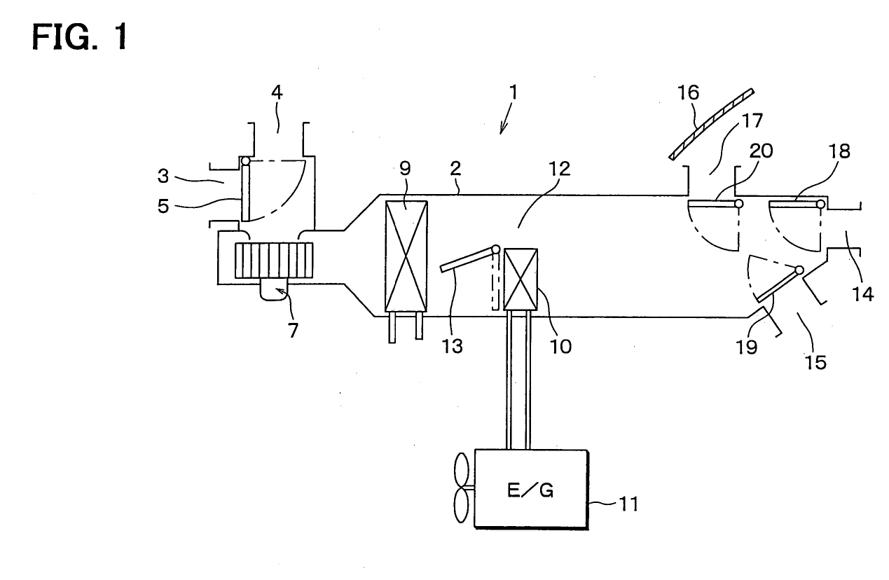

FIG. 1 shows a schematic diagram of an air conditioner 1 for a vehicle according to a first embodiment of the present invention. In the first embodiment, an electrical connector for an actuator is applied to the air conditioner 1.

The air conditioner 1 has an air conditioner casing 2 as an air passage. An inside air suction port 3, an outside air suction port 4, and an inside/outside air switching door 5 are disposed upstream of the air conditioner casing 2. The inside air suction port 3 sucks the inside air. The outside air suction port 4 sucks the outside air. The inside/outside air switching door 5 selectively opens and closes the inside air suction port 3 and the outside air suction port 4.

A filter (not shown) and an air blower 7 are disposed downstream of the inside/outside air switching door 5. The filter removes dust in the air. The air blower 7 sucks the air through the inside and outside air suction ports 3, 4. Then, the air blower 7 blows the sucked air to each air blow port 14, 15, 17.

An evaporator 9 is disposed downstream of the air blower 7. The evaporator 9 cools the air blowing into a vehicle compartment. All of the air blown by the air blower 7 passes through the evaporator 9. A heater core 10 is disposed downstream of the evaporator 9. The heater core 10 heats the air blowing into the vehicle compartment. The heater core 10 uses coolant of an engine 11 as a heat source.

The air conditioner casing 2 has a bypass passage 12. The airflow can bypass the heater core 10 through the bypass passage 12. An air mix door 13 is disposed upstream of the heater core 10. The air mix door 13 adjusts an airflow ratio between the quantity of the airflow flowing through the heater core 10 and the quantity of the airflow flowing through the bypass passage 12 to control the temperature of the air flowing into the vehicle compartment.

A face blowout port 14, a foot blowout port 15, and a defroster blowout port 17 are disposed at the most downstream of the air conditioner casing 2. The face blowout port 14 blows conditioned air toward an upper body of a passenger in the vehicle compartment. The foot blowout port 15 blows the conditioned air toward a lower body of the passenger. The defroster blowout port 17 blows the conditioned air toward an inner surface of a windshield 16 of the vehicle. Blowout mode switching doors 18, 19, 20 are rotatably installed upstream of the face blowout port 14, the foot blowout port 15, and the defroster blowout port 17, respectively.

The blowout mode switching doors 18, 19, 20, the air mix door 13, and the inside/outside air switching door 5 are opened and closed by respective motor-driven actuator 21, such as a servomotor Mo.

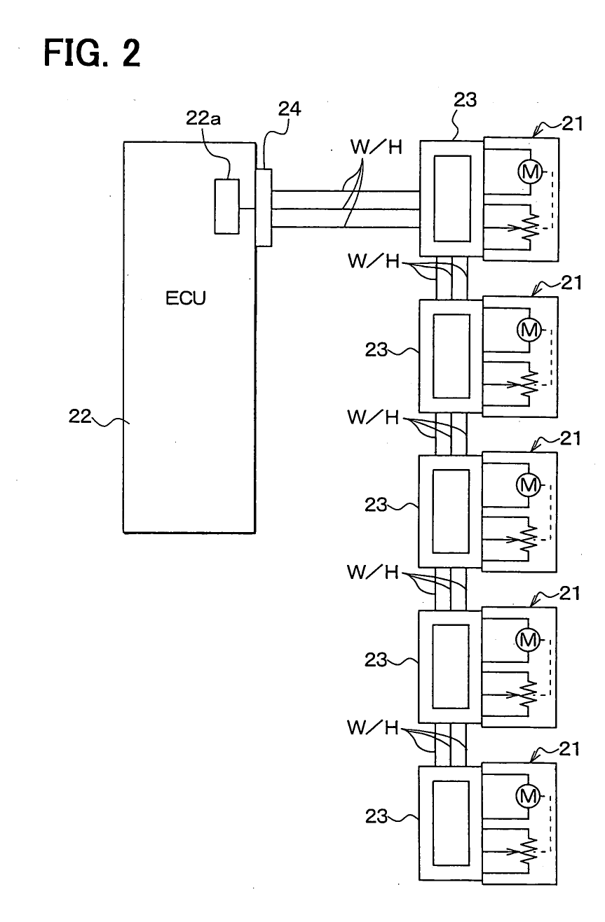

FIG. 2 shows a block diagram of a control system of the air conditioner. As shown in FIG. 2, the actuators 21 are connected to respective electrical connectors 23. An ECU 22 has a communication unit 22a and an ECU connector 24. The actuators 21 are electrically connected to the communication unit 22a of the ECU 22 in series via the ECU connector 24, wiring harnesses W/H, and the electrical connectors 23 for the actuators 21. Each actuator 21 is controlled by the ECU 22.

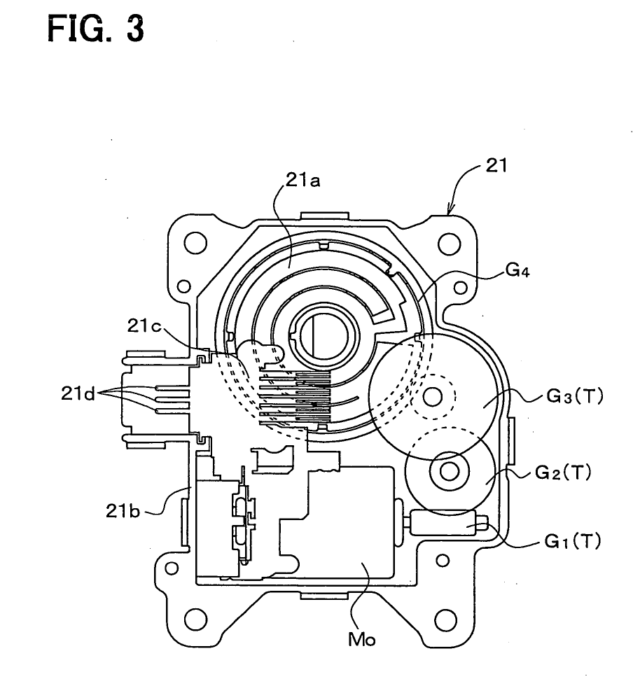

As shown in FIG. 3, the actuator 21 has the servomotor Mo, a reduction gear T, and an output gear G4. The reduction gear T has a plurality of gears G1, G2, G3. The output gear G4 has a printed board 21a. The printed board 21a has an arc shaped conductive portion and an arc shaped nonconductive portion. The printed board 21a is integrally rotated with the output gear G4. The actuator 21 also has a casing 21b. The casing 21b has a plate contact 21c. The plate contact 21c slidably contacts the printed board 21a. The plate contact 21c and the printed board 21a constitute a potentiometer, which detects a rotational angle of the output gear G4.

The casing 21b also has male connectors 21d. The male connectors 21d electrically connect to the plate contact 21c and the servomotor Mo. The detected signal for the rotational angle of the output gear G4 and supply current for driving the servomotor Mo are sent and received via the male connectors 21d.

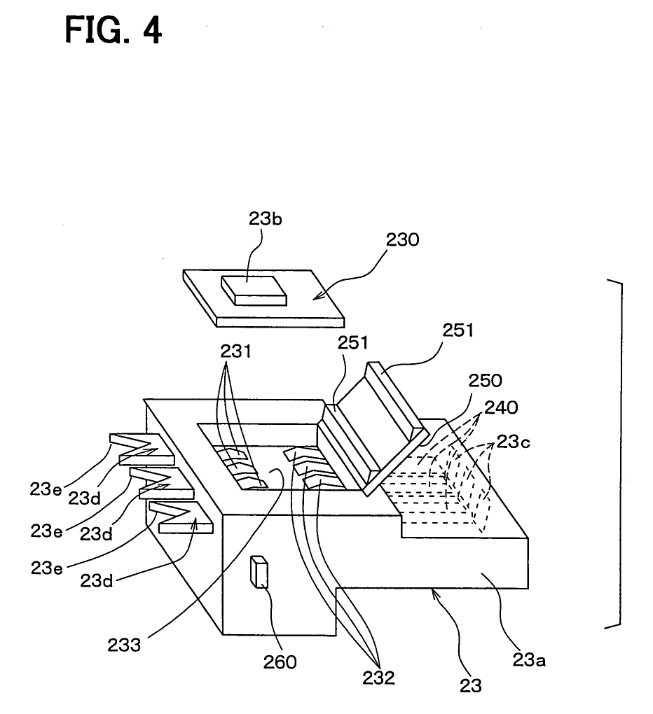

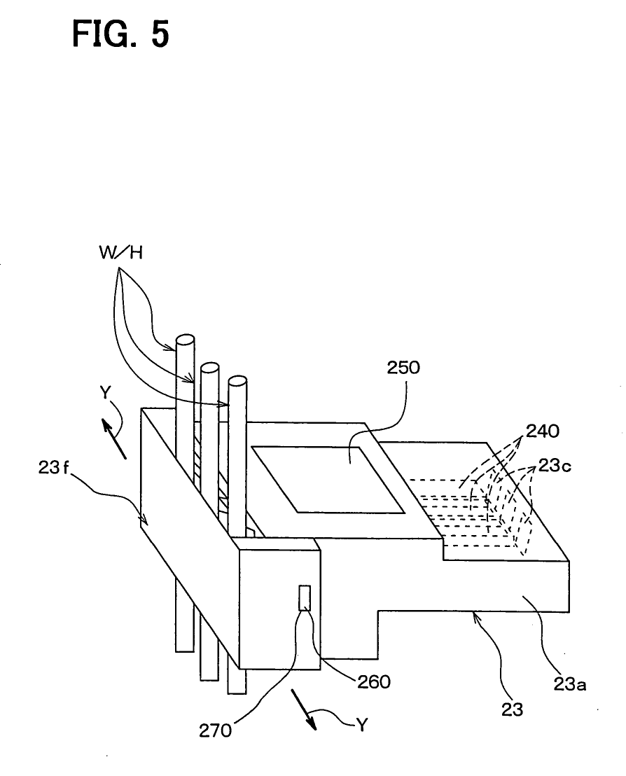

The electrical connection between ECU 22 and each actuator 21 will be explained with reference to FIGS. 4, 5. FIGS. 4, 5 show schematic diagrams of the electrical connector 23. The electrical connector 23 is connected to an actuator side of the wiring harness W/H, which connects between the ECU 22 and the actuator 21.

As shown in FIGS. 4, 5, the connector 23 has a connector housing 23a. The connector housing 23a is made of resin, and has a rectangular shape. The connector housing 23a has a hole 233. The connector housing 23a houses a circuit board 230, first terminals 231, and second terminals 232.

The circuit board 230 is disposed in the hole 233. An integrated circuit (IC) 23b is mounted on the circuit board 230. A motor driving circuit and a communication circuit are integrated in the IC 23b. That is, they are packed in one chip. The motor driving circuit produces a control signal to control the actuator 21 (the motor Mo). The communication circuit communicates different signals with the motor driving circuit and the ECU 22. The different signals include a signal for controlling the motor driving circuit in response to an input signal from the ECU 22. The different signals also include other signals that are produced from the potentiometer and the motor driving circuit. The motor driving circuit and the communication circuit constitute a control circuit of the present invention.

The first terminals 231 and the second terminals 232 are provided on the bottom of the hole 233. The first terminals 231 are made of phosphor bronze or any other acceptable material. The first terminals 231 are integrally formed with respective harness terminals 23d. Each first terminal 231 has a curved shape (a bent shape). The first terminals 231 contact respective first electrodes (not shown) provided on the underside of the circuit board 230.

The second terminals 232 are made of phosphor bronze or any other acceptable material. The second terminals 232 are integrally formed with respective contact terminals 240. Each second terminal 232 has a curved shape (a bent shape). The second terminals 232 contact respective second electrodes (not shown) provided on the underside of the circuit board 230.

The connector housing 23a has a lid 250. The hole 233 can be opened and closed by the lid 250. Protrusions 251 are provided on the underside of the lid 250. The protrusions 251 push the circuit board 230 against the first and second terminals 231, 232 when the lid 250 is closed. Accordingly, they improve contact performance between the circuit board 230 and the terminals 231, 232.

The connector housing 23a has openings 23c, which the male connectors 21d of the actuator 21 are plugged into. The contact terminals 240 are provided in respective openings 23c. The contact terminals 240 are electrically connected to the respective second terminals 232. The contact terminals 240 contact the male connectors 21d of the actuator 21 when the male connectors 21d are plugged into the openings 23c.

The connector housing 23a also has the harness terminals 23d. The harness terminals 23d are provided so that the harness terminals 23d protrude from the connector housing 23a. The harness terminals 23d are electrically connected to the respective wiring harnesses W/H. The harness terminal 23d has V-shape notch 23e on its top end. The wiring harness W/H is electrically connected to the harness terminal 23d so that the wiring harness W/H is embedded in the V-shape notch 23e in a condition that the wiring harness W/H is held between the connector housing 23a and a cover 23f.

In detail, when the wiring harness W/H is inserted in the V-shape notch 23e, insulation coating of the wiring harness W/H is cut by the V-shape notch 23e. Thus, a core wire within the insulation coating of the wiring harness W/H is electrically conducted to the harness terminal 23d.

As shown in FIG. 5, the cover 23f has a C-shape at its cross section, and has joint openings 270. Joint protrusions 260 of the connector housing 23a are inserted into the joint openings 270 so that the cover 23f is held onto the connector housing 23a.

The harness terminals 23d have three terminals. One of the harness terminals 23d is used as a power line. Another terminal is used as a ground line. The other terminal is used as a command line (data communication line) for the control signal. The control signal is sent and received based on a certain protocol.

Next, a method for assembling the electrical connector 23 will be explained. The male connectors 21d of the actuator 21 are inserted into the openings 23c of the electrical connectors 23. The male connectors 21d contact the respective contact terminals 240. Accordingly, the male connectors 21d electrically connected to the respective second terminals 232 via the respective contact terminals 240.

The cover 23f is pressed to the connector housing 23a in a condition that the wiring harnesses W/H are inserted in the respective V-shape notches 23e. At that time, the cover 23f is elastically deformed in an arrow direction Y (shown in FIG. 5) so that the cover 23f is broadened by the connector housing 23a. Then, the joint protrusions 260 are inserted into the joint openings 270. Thus, the cover 23f is held onto the connector housing 23a.

At the same time, the insulation coating of the wiring harnesses W/H are cut by the V-shape notches 23e, so that the core wire within the insulation coating of the wiring harnesses W/H are electrically connected to the harness terminals 23d. Accordingly, the wiring harnesses W/H are electrically connected to the respective first terminals 231 via the respective V-shape notch 23e and the respective harness terminals 23d.

After that, the lid 250 is opened by an operator. The circuit board 230 is disposed on the first and second terminals 231, 232 in the hole 233. Then, the lid 250 is closed, so that the circuit board 230 is pushed by the protrusions 251. The first and second terminals 231, 232 are elastically deformed, and the circuit board 230 is electrically connected to the first and second terminals 231, 232 at the first and second electrodes provided on the underside of the circuit board 230.

If the circuit board 230 is broken down, the lid 250 is opened and the circuit board 230 is removed from the hole 233 by the operator. Then, a new circuit board 230 is provided on the terminals 231, 232 instead of the broken circuit board 230, and the lid 250 is closed. At that time, as described above, the first and second terminals 231, 232 are elastically deformed, and the circuit board 230 is electrically connected to the first and second terminals 231, 232 at the first and second electrodes.

Since the circuit board 230 is detachable in the connector housing 23a as described above, it is easy to change the circuit board 230 independently even if the circuit board 230 is broken down. This reduces a cost of the change, and it is easy to repair the electrical connector 23.

### Second Embodiment

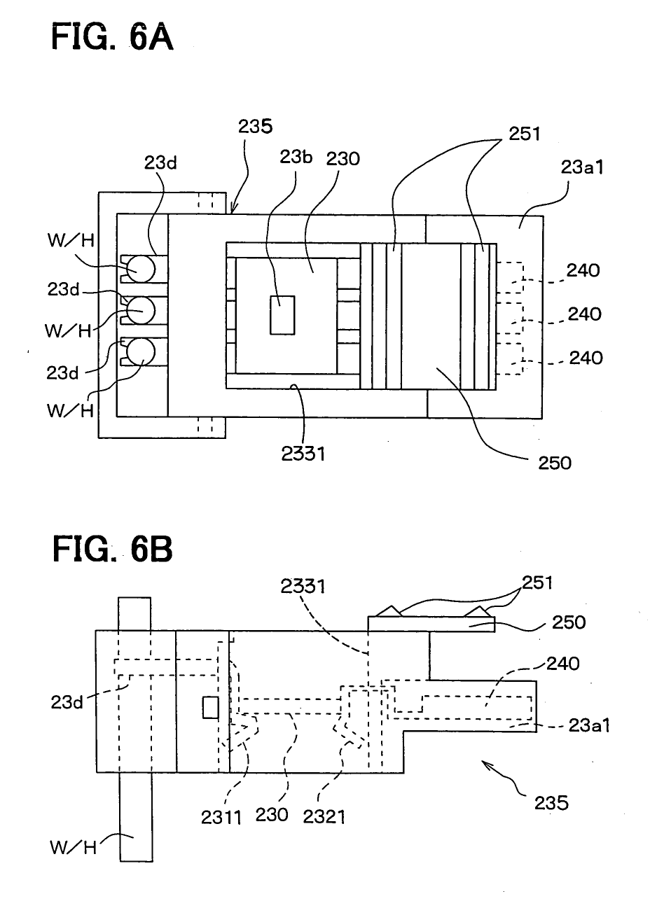

In the first embodiment, the circuit board 230 is disposed on the first and second terminals 231, 232 in the hole 233 of the connector housing 23a so that the circuit board 230 is electrically connected to the terminals 231, 232. Instead, as shown in FIGS. 6A, 6B, the second embodiment uses different first terminals 2311 and different second terminals 2321.

An electrical connector 235 has a connector housing 23al. The connector housing 23al has a through-hole 2331. The first terminals 2311 and the second terminals 2321 are provided in the through-hole 2331. The first terminals 2311 are disposed on an inner wall of the through-hole 2331, and are connected to the respective harness terminals 23d. The second terminals 2321 are disposed on an opposite wall of the through-hole 2331, and are connected to the respective contact terminals 240. The terminals 2311, 2321 are elastically and independently deformed, so that the circuit board 230 is inserted between the first terminals 2311 and the second terminals 2321. Electrodes of the circuit board 230 electrically contact the terminals 2311, 2321 at sides of the circuit board 230.

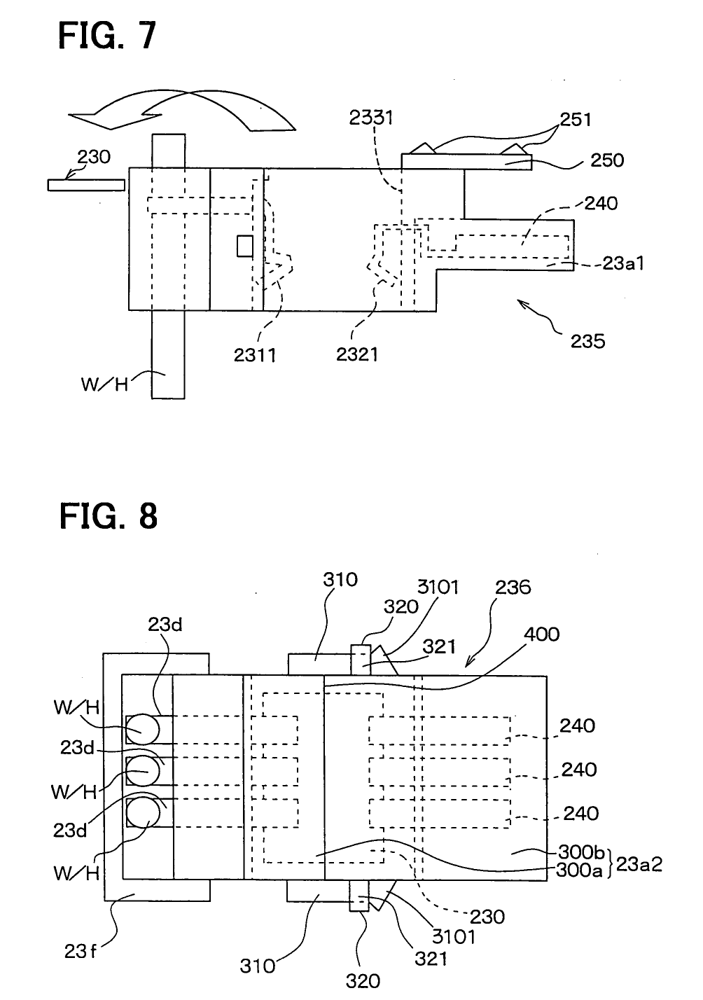

As shown in FIG. 7, if the circuit board 230 is broken down, the circuit board 230 can be independently changed in the second embodiment as in the first embodiment. This reduces a cost of the change, and it is easy to repair the electrical connector 235.

### Third Embodiment

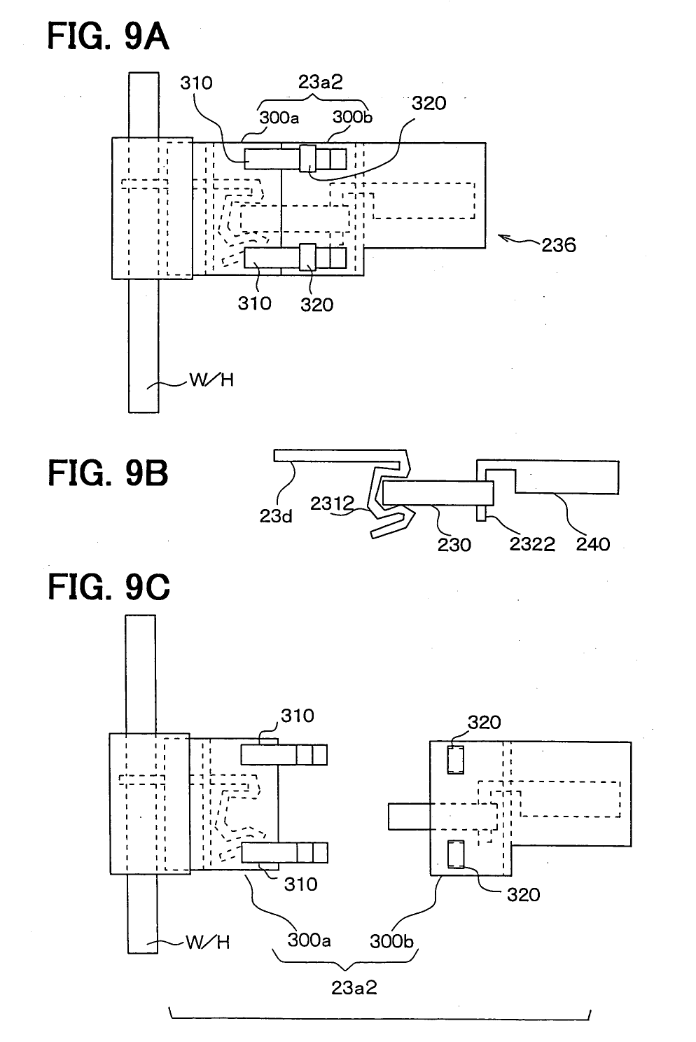

In the first and second embodiments, the circuit board 230 is removed from the hole 233 and the through-hole 2331, and the new circuit board 230 is disposed. Instead, as shown in FIGS. 8, 9A-9C, the circuit board 230 is removed by disassembling a dividable connector housing 23a2 in the third embodiment.

In the third embodiment, as shown in FIG. 8, an electrical connector 236 has the dividable connector housing 23a2. The connector housing 23a2 has a first housing 300a and a second housing 300b. The connector housing 23a2 can be disassembled into the housings 300a, 300b.

The first housing 300a has joints 310 on both of its sides. The joints 310 protrude toward the second housing 300b beyond a dividing surface 400 of the housings 300a, 300b. The joints 310 have edge portions 3101. The edge portions 3101 are wider than openings 321 of protrusions 320.

The second housing 300b has the protrusions 320 on both of its sides. The protrusions 320 have respective openings 321. The joints 310 are inserted into the openings 321, so that the housings 300a, 300b are connected to each other.

As shown in FIGS. 9A, 9B, first terminals 2312 are provided in the first housing 300a. The first terminals 2312 are elastically deformed, and the circuit board 230 is held on its side by the first terminals 2312. The first terminals 2312 are electrically connected to the electrodes of the circuit board 230.

Second terminals 2322 are provided in the second housing 300b. The second terminals 2322 are inserted into the circuit board 230 to be fixed to the circuit board 230. The second terminals 2322 are electrically connected to the electrodes of the circuit board 230.

As shown in FIG. 9C, if the circuit board 230 is broken down, the connector housing 23a2 is disassembled. At that time, the second housing 300b, the second terminals 2322, and the circuit board 230 are integrally divided from the first housing 300a. The combined part, which has the second housing 300b, the second terminals 2322, and the circuit board 230, is changed to a new combined part in order to change the circuit board 230. Instead, the second terminals 2322 and the circuit board 230 may be changed to new parts by further disassembling from the second housing 300b.

### Fourth Embodiment

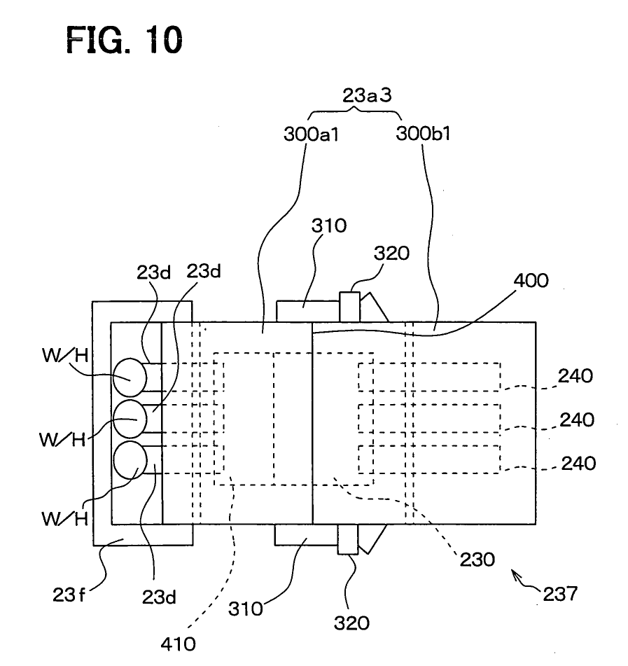

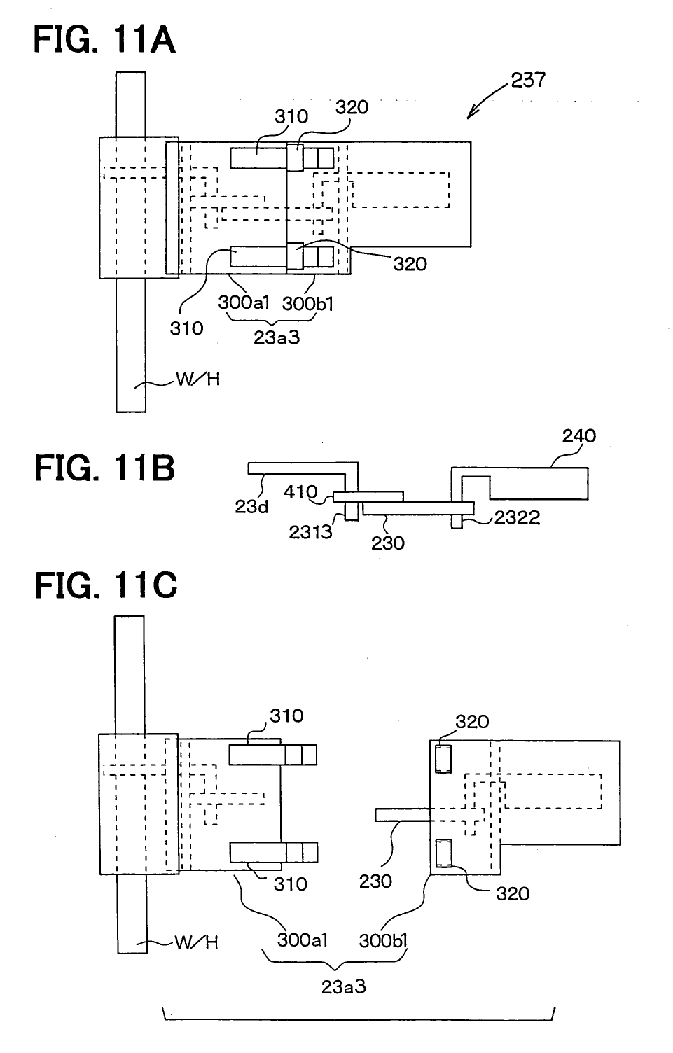

In the third embodiment, the circuit board 230 is held on its side by the first terminals 2312 in the first housing 300a, and the first terminals 2312 are electrically connected to the electrodes of the circuit board 230. Instead, as shown in FIGS. 10, 11A-11C, different first terminals 2313 are electrically connected to the electrodes of the circuit board 230 via a relay board 410.

In the fourth embodiment, an electrical connector 237 has a dividable connector housing 23a3. The connector housing 23a3 has another first housing 300a1 and another second housing 300b1. The connector housing 23a3 can be disassembled into the housings 300a1, 300b1. The first terminals 2313 are provided in the first housing 300a1.

The relay board 410 is made of conductive metal. The first terminals 2313 are inserted through the relay board 410, and the relay board 410 is fixed to the first terminals 2313. The relay board 410 is electrically connected to electrodes provided on the surface of the circuit board 230 at the backside of the relay board 410. Thus, the first terminals 2313 are electrically connected to the circuit board 230 via the relay board 410.

As shown in FIG. 11C, if the circuit board 230 is broken down, the connector housing 23a3 is disassembled. At that time, the second housing 300b1, the second terminals 2322, and the circuit board 230 are integrally divided from the first housing 300a1 as in the third embodiment. The circuit board 230 is changed to a new circuit board 230 by changing the combined part, which has the second housing 300b1, the second terminals 2322, and the circuit board 230.

### Fifth Embodiment

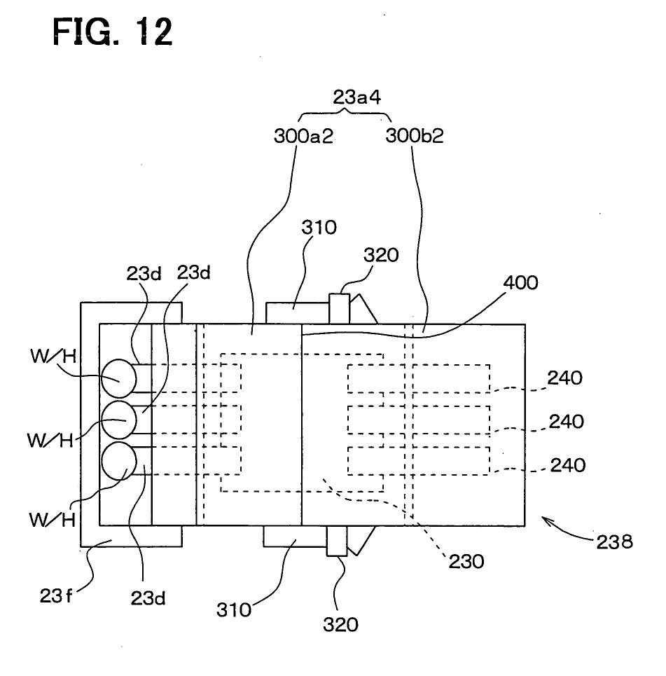

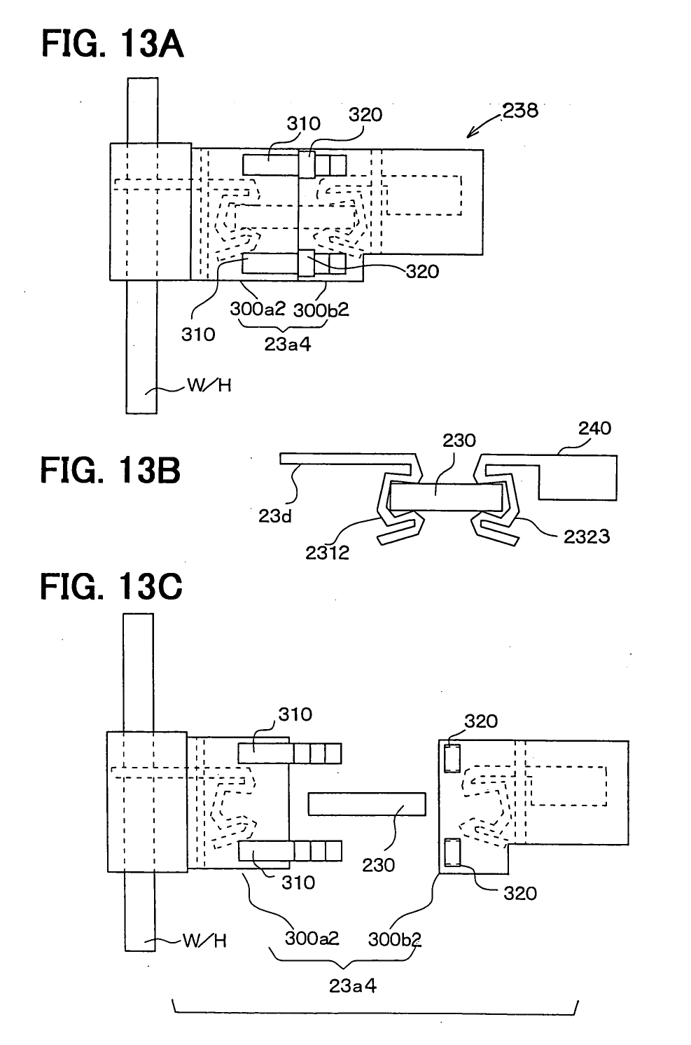

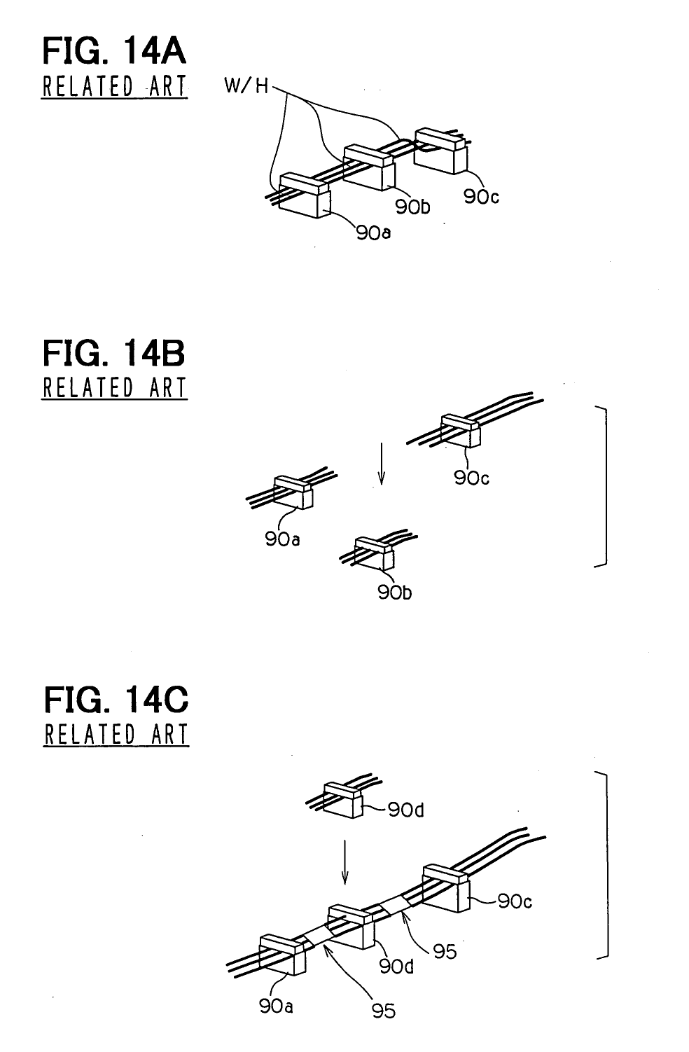

In the third and fourth embodiments, the second housings 300b, 300b1, the second terminals 2322, and the circuit boards 230 are integrally divided from the first housings 300a, 300a1. Instead, as shown in FIGS. 12, 13A-13C, the circuit board 230 can be independently changed by disassembling a dividable connector housing 23a4 in the fifth embodiment.

In the fifth embodiment, an electrical connector 238 has the dividable connector housing 23a4. The connector housing 23a4 has a first housing 300a2 and a second housing 300b 2. The connector housing 23a4 can be disassembled into the housings 300a2, 300b2.

As shown in FIGS. 13A, 13B, the first terminals 2312 are provided in the first housing 300a2, and second terminals 2323 are provided in the second housing 300b2. Each of the first and second terminals 2312, 2323 has a curved shape (a bent shape) so that the first and second terminals 2312, 2323 are elastically and independently deformed and the circuit board 230 is electrically held between the first terminals 2312 and the second terminals 2323. Therefore, if the circuit board 230 is broken down, the circuit board 230 is independently changed by disassembling the connector housing 23a4.

### Another Embodiment

The present invention should not be limited to the embodiments discussed above and shown in the figures, but may be implemented in various ways without departing from the spirit of the invention.

For example, in the foregoing embodiments, the wiring harnesses W/H are inserted in the V-shape notches 23e, so that the core wires within the insulation coating of the wiring harnesses W/H are electrically connected to the harness terminals 23d. Instead, the core wires can be electrically connected to the harness terminals 23d by other methods, such as soldering, pressure welding, and pressing.

In the foregoing embodiments, the electrical connector for the actuator is applied to the vehicle air conditioner. Instead, the electrical connector can be applied to other control systems for other actuators using other networks.

What is claimed is:

1. An electrical connector for connecting an actuator to a wiring harness connected to an electrical control unit, the electrical connector comprising:
a housing;
a circuit board that is detachably housed in the housing and has a control circuit that produces a control signal to control the actuator based on an input signal from the electrical control unit via the wiring harness;
a harness terminal that connects the wiring harness to the circuit board; and
an actuator terminal that connects the actuator to the circuit board.

2. The electrical connector according to claim 1, wherein the circuit board is disposed in a hole of the housing, the electrical connector further comprising:
a first terminal that is housed in the hole and is electrically connected to the harness terminal and the circuit board; and
a second terminal that is housed in the hole and is electrically connected to the actuator terminal and the circuit board.

3. The electrical connector according to claim 2, wherein the first terminal and the second terminal are independently and elastically deformed so that the circuit board is electrically held between the first terminal and the second terminal when the circuit board is housed in the hole.

4. The electrical connector according to claim 1, wherein the housing has a first housing and a second housing, the electrical connector further comprising:
a first terminal that is housed in the first housing and is electrically connected to the harness terminal and the circuit board; and
a second terminal that is housed in the second housing and is electrically connected to the actuator terminal and the circuit board.

5. The electrical connector according to claim 4, wherein the first terminal and the second terminal are independently and elastically deformed so that the circuit board is held between the first terminal and the second terminal when the first housing and the second housing are combined with each other.

6. The electrical connector according to claim 4, wherein the second terminal is fixed to the circuit board, and
the first terminal is elastically deformed so that the circuit board is held between the first terminal and the second terminal when the first housing and the second housing are combined with each other.

7. The electrical connector according to claim 4, further comprising:
a relay board that is electrically fixed to the first terminal; wherein
the second terminal is fixed to the circuit board, and
the relay board is electrically connected to the circuit board when the first housing and the second housing are combined with each other.

8. The electrical connector according to claim 1, wherein the harness terminal has a V-shape notch that cuts insulation coating of the wiring harness so that a core wire within the insulation coating of the wiring harness is electrically connected and held.
